(19) United States
(12) Patent Application Publication
(10) Pub. No.: US 2004/0222928 A1
(43) Pub. Date: Nov. 11, 2004

(54) Multi-frequency antenna module for a portable electronic apparatus

(75) Inventor: Farchien Chen, Taipei City (TW)

Correspondence Address: LADAS & PARRY, 5670 WILSHIRE BOULEVARD, SUITE 2100, LOS ANGELES, CA, 90036-5679, US

(73) Assignee: QUANTA COMPUTER INC.

(21) Appl. No.: 10/434,007

(22) Filed: May 7, 2003

(51) Int. Cl. H01Q 1/24

(52) U.S. Cl. 343/702

(57) ABSTRACT

A multi-frequency antenna module for a portable electronic apparatus includes a dielectric substrate mounted in a housing of the apparatus. A micro-strip conductor is disposed on a first surface of the substrate. A radiating element is disposed on an opposite second surface of the substrate and is coupled electrically to the micro-strip conductor. A grounding metal plate is mounted on the second surface of the substrate and is coupled electrically to the radiating element. A transmission line has a first conducting portion coupled electrically to the micro-strip conductor, and a second conducting portion coupled electrically to the grounding metal plate.

### BACKGROUND OF THE INVENTION

1. Field of the Invention

This invention relates to an antenna, more particularly to a multi-frequency antenna module for a portable electronic apparatus.

2. Description of the Related Art

FIG. 1 illustrates conventional slot antennas 21, 22 embedded in a notebook computer 1. The conventional slot antennas 21, 22 are soldered on a display frame 12 of the notebook computer 1, and are grounded through the display frame 12. However, since the conventional slot antennas 21, 22 are formed by bending or pressing and have a relatively small size, it is difficult to solder accurately and manually the slot antennas 21, 22 to the display frame 12, thereby resulting in a reduced yield. Furthermore, the conventional antennas 21, 22 are designed for a single frequency band, such as 2.4 GHz corresponding to the IEEE802.11b communications protocol.

### SUMMARY OF THE INVENTION

Therefore, the object of the present invention is to provide a multi-frequency antenna module for a portable electronic apparatus.

According to the present invention, there is provided a multi-frequency antenna module for a portable electronic apparatus with a housing. The antenna module comprises:

a dielectric substrate adapted to be mounted in the housing and having opposite first and second surfaces;

a micro-strip conductor disposed on the first surface of the substrate;

a radiating element disposed on the second surface of the substrate and coupled electrically to the micro-strip conductor;

a grounding metal plate mounted on the second surface of the substrate and coupled electrically to the radiating element; and

a transmission line having a first conducting portion coupled electrically to the micro-strip conductor, and a second conducting portion coupled electrically to the grounding metal plate.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective view showing conventional antennas installed in a portable computer;

FIG. 2 is a perspective view showing a portable electronic apparatus with the preferred embodiment of a multi-frequency antenna module according to the present invention;

FIG. 3 is a perspective view showing the preferred embodiment;

FIG. 4 is a schematic rear view showing the preferred embodiment;

FIGS. 5 and 6 are plots showing VSWR charts of the preferred embodiment when disposed on left and right sides of the portable electronic apparatus;

FIG. 7 is a table showing VSWR charts of the preferred embodiment when disposed on the left and right sides of the portable electronic apparatus;

FIGS. 8 and 9 show gain charts of the preferred embodiment when disposed on the left and right sides of the portable electronic apparatus in a horizontal plane at 2.45 GHz, respectively;

FIGS. 10 and 11 show gain charts of the preferred embodiment when disposed on the left and right sides of the portable electronic apparatus in a vertical plane at 2.45 GHz, respectively;

FIGS. 12 and 13 show gain charts of the preferred embodiment when disposed on the left and right sides of the portable electronic apparatus in a horizontal plane at 5.25 GHz, respectively; and

FIGS. 14 and 15 show gain charts of the preferred embodiment when disposed on the left and right sides of the portable electronic apparatus in a vertical plane at 5.2.5 GHz, respectively.

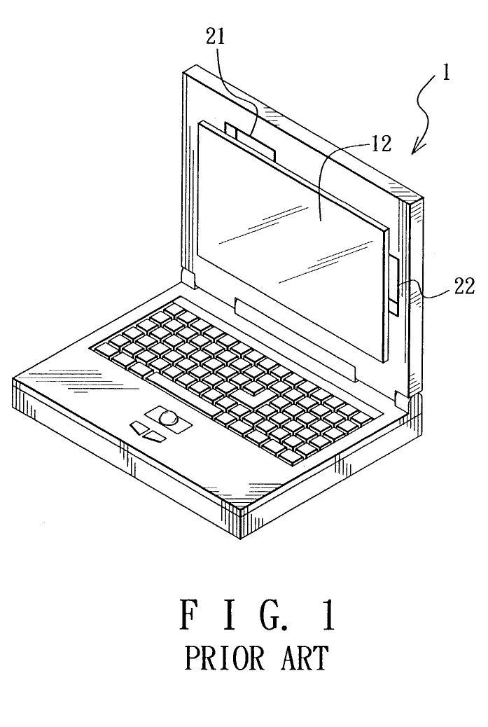

### DETAILED DESCRIPTION OF THE PREFERRED EMBODIMENT

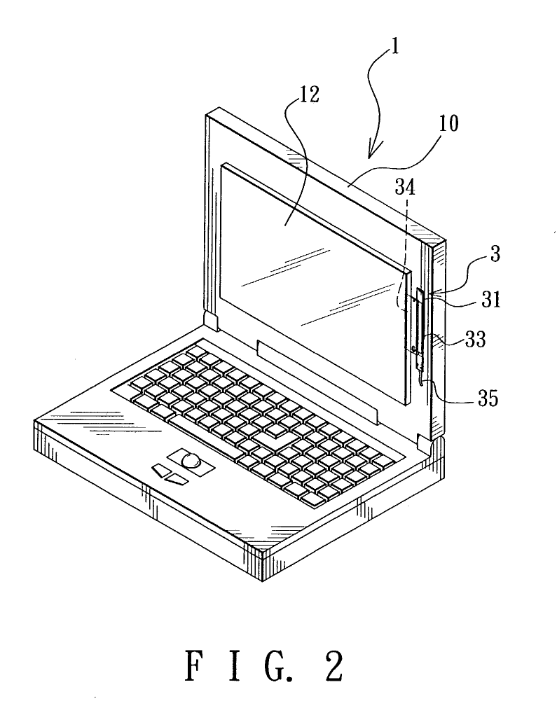

Referring to FIG. 2, the preferred embodiment of a multi-frequency antenna module 3 for a portable electronic apparatus 1, such as a notebook computer, according to the present invention enables the portable electronic apparatus 1 to execute wireless communication according to IEEE802.11a and IEEE802.11b. The antenna module 3 is also suitable for use in a personal digital assistant, a tablet personal computer or a pocket personal computer. In this embodiment, the apparatus 1 has a housing 10 with a metal frame 12 disposed therein for supporting a display panel (not shown) thereon.

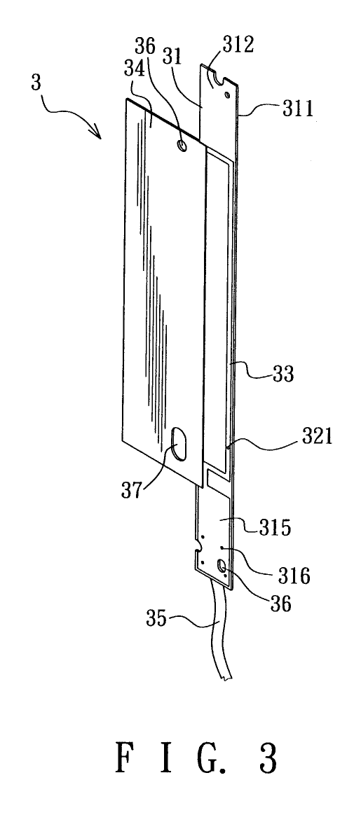

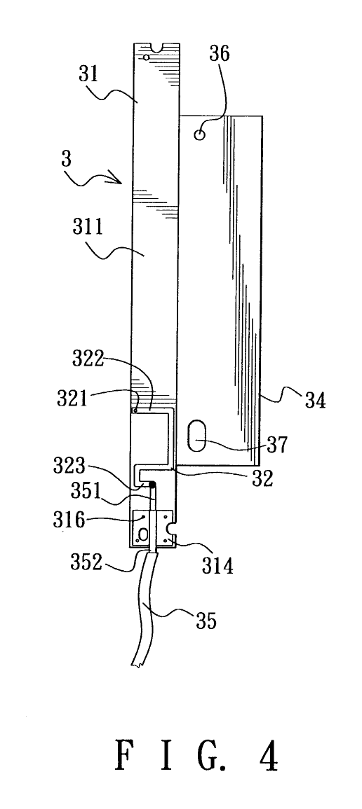

Referring to FIGS. 3 and 4, the multi-frequency antenna module 3 of the preferred embodiment is shown to include a dielectric substrate 31, a micro-strip conductor 32, a radiating element 33, a grounding metal plate 34, and a transmission line 35.

The substrate 31 is adapted to be mounted in the housing 10 and has opposite first and second surfaces 311, 312. In this embodiment, the substrate 31 is a printed circuit board formed with a fastener hole 36.

The micro-strip conductor 32 is formed on the first surface 311 of the substrate 31 and has opposite first and second end portions 322, 323.

The radiating element 33 is formed on the second surface 312 of the substrate 31 and is coupled electrically to the micro-strip conductor 32. In this embodiment, the radiating element 33 is a slot antenna, and is coupled electrically to the micro-strip conductor 32 by means of a conductive via 321 that extends through the radiating element 33, the substrate 31 and the first end portion 322 of the conductor 32.

The grounding metal plate 34 is mounted on the second surface 312 of the substrate 31, and is coupled electrically to the radiating element 33. In this embodiment, the grounding metal plate 34 is made of copper, is soldered on the second surface 312 of the substrate 31, and is formed with a fastener hole 37 (see FIG. 3). The grounding metal plate 34 is adapted to be adhered onto the metal frame 12 of the portable electronic apparatus 1, as shown in FIG. 2. Alternatively, the grounding metal plate 34 or the substrate 31 may be fastened on the metal frame 12 by means of a fastener (not shown) extending through the fastener hole 36 or 37.

The transmission line 35, which is adapted to be coupled electrically to a radio frequency circuit (not shown) in the portable electronic apparatus 1, has a first conducting portion 351 coupled electrically to the second end portion 323 of the conductor 32 by soldering, and a second conducting portion 352 coupled electrically to the grounding metal plate 34. In this embodiment, the transmission line 35 is a coaxial cable. The first conducting portion 351 is an inner conductor, whereas the second conducting portion 352 is an outer conductor of the coaxial cable. The second conducting portion 352 is coupled electrically to the grounding metal plate 34 through a first conductive portion 314 formed on the first surface 311 of the substrate 31 and isolated electrically from the conductor 32 (see FIG. 4), a conductive via 316 that extends through the first conductive portion 314, the substrate 31, and a second conductive portion 315 (see FIG. 3) formed on the second surface 312 of the substrate 31 and connected electrically to the grounding metal plate 34. As such, the radiating element 33 and the conductor 32 can be grounded through the transmission line 35.

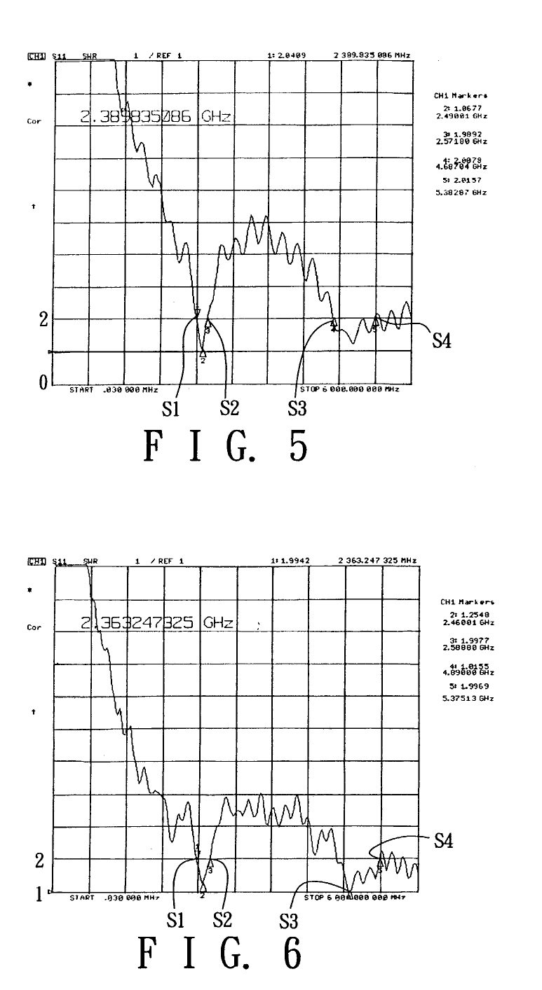

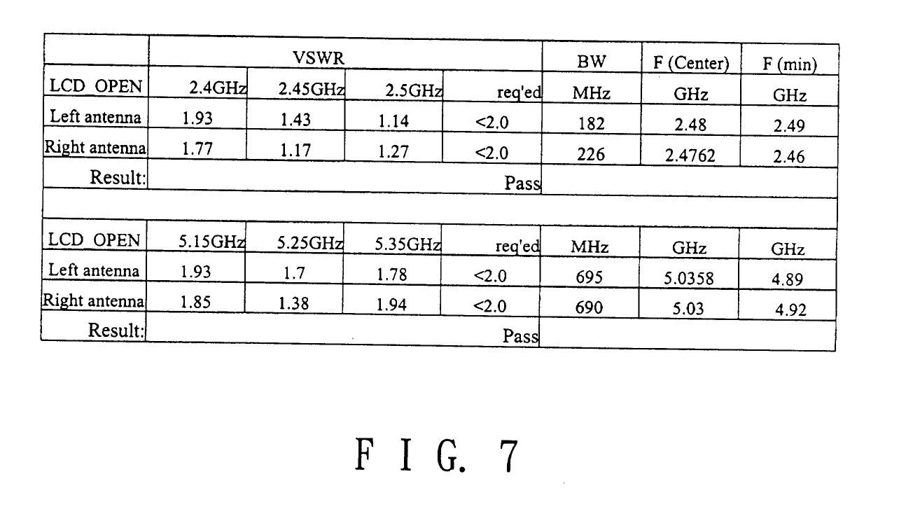

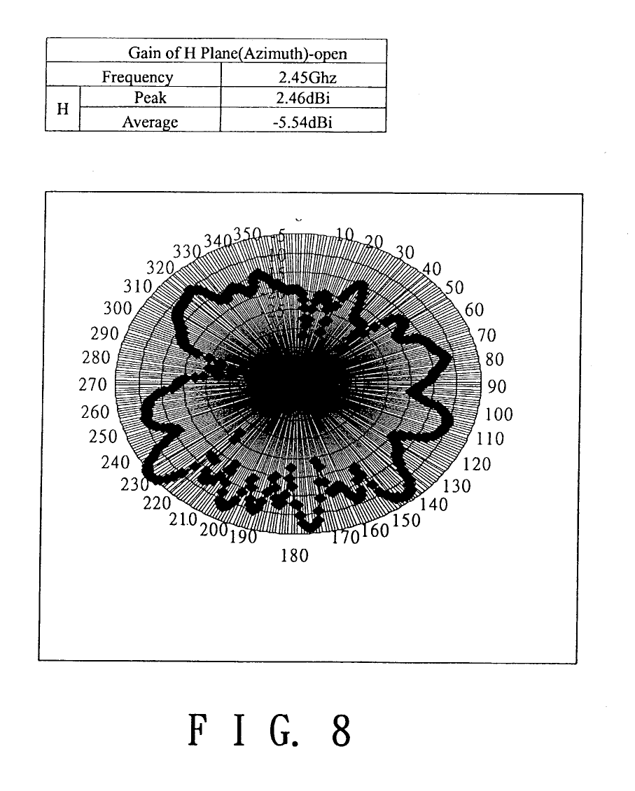

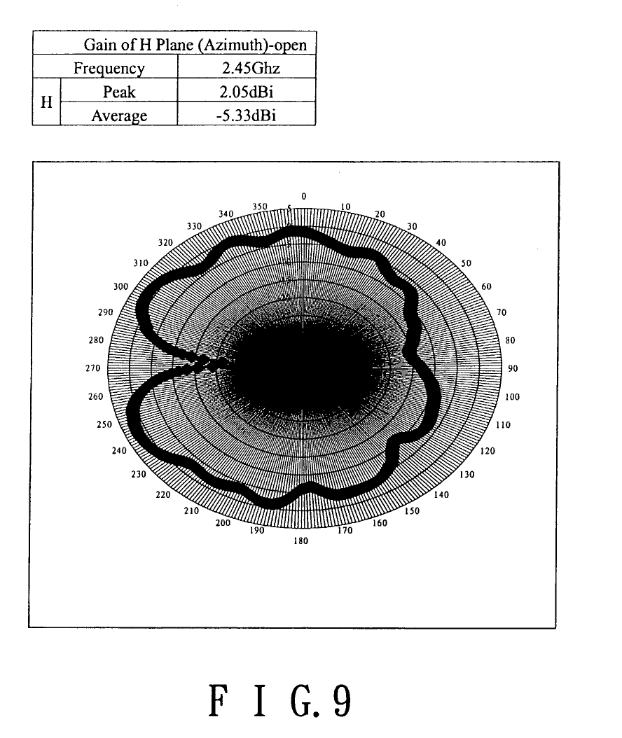

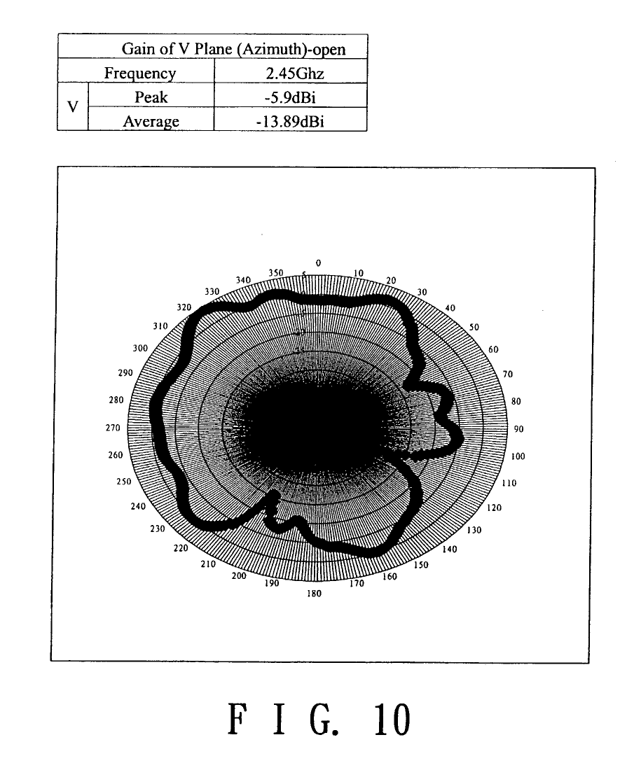

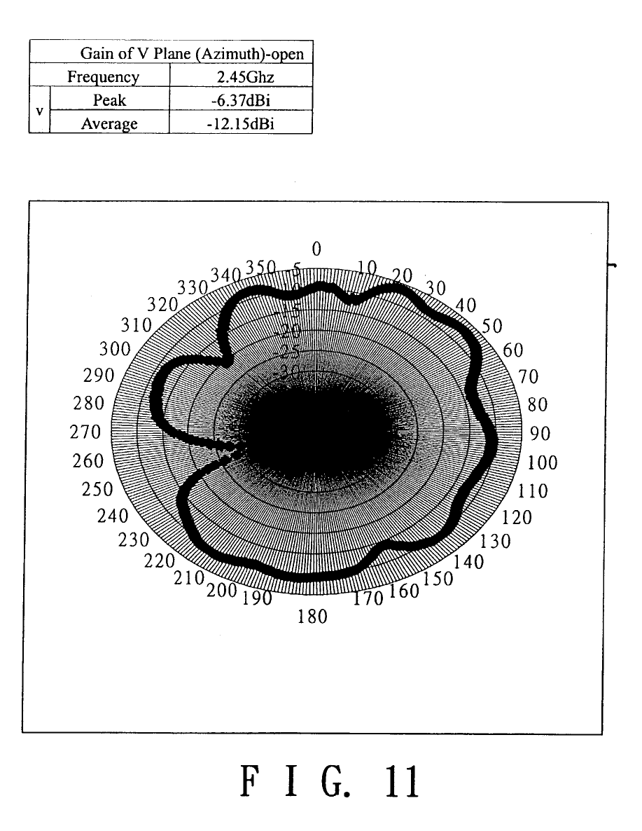

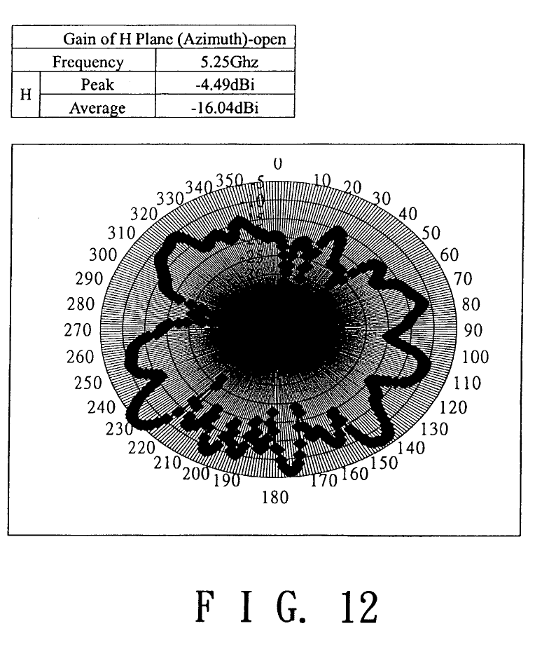

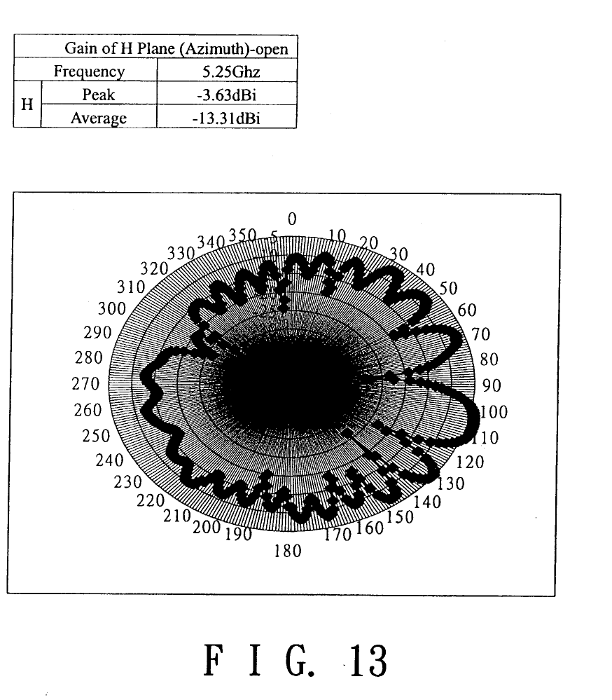

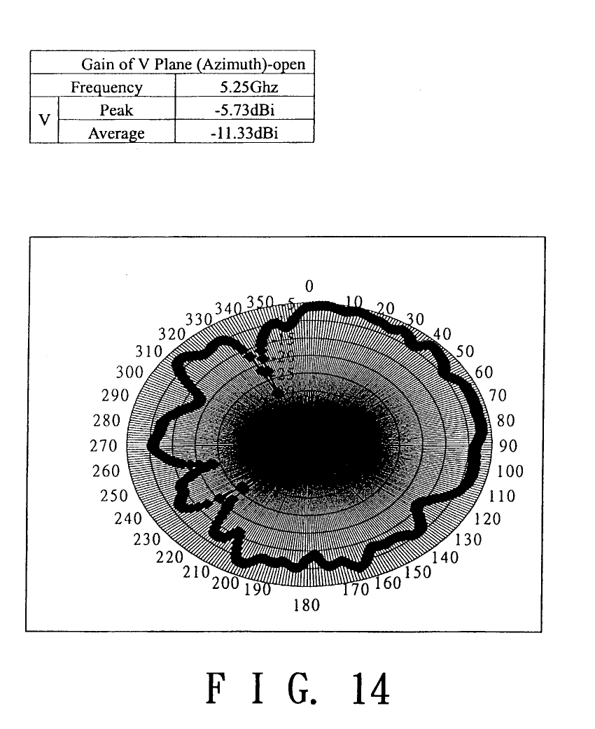

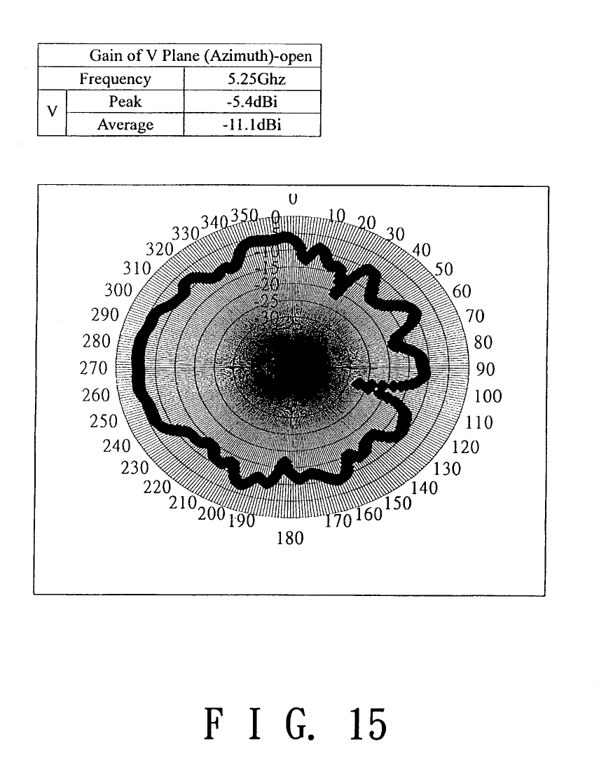

FIGS. 5 and 6 show the measured voltage standing wave ratio (VSWR) for the antenna module 3 of the present invention when the latter is mounted on left and right sides of the portable electronic apparatus 1. In the chart of FIG. 5, standing wave ratios at points S1, S2, S3, S4 are substantially equal to 2. The point S1 is located at 2.39 GHz, the point S2 is located at 2.57 GHz, the point S3 is located at 4.69 GHz, and the point S4 is located at 5.38 GHz. In the chart of FIG. 6, standing wave ratios at points S1, S2, S3, S4 are substantially equal to 2. The point S1 is located at 2.36 GHz, the point S2 is located at 2.57 GHz, the point S3 is located at 4.89 GHz, and the point S4 is located at 5.38 GHz. According to FIG. 7, which is a table showing the measured VSWR for the antenna module 3 of the present invention when the latter is disposed on the left and right sides of the portable electronic apparatus 1, all VSWRs at 2.4 GHz, 2.45 GHz, 2.5 GHz, 5.15 GHz, 5.25 GHz and 5.35 GHz are less than 2. As such, the resultant bandwidths are wide enough for the 2.4 GHz ISM band, which has a bandwidth requirement of about 83.5 MHz, and the 5.15 GHz ISM band, which has a bandwidth requirement of about 200 MHz according to the IEEE802.11b and IEEE802.11a protocols. FIGS. 8 to 15 illustrate measured performances of the antenna module 3 in horizontal and vertical planes at 2.45 GHz and 5.25 GHz when disposed on the left and right sides of the portable electronic apparatus 1.

The radiating element (slot antenna) 33 can be formed precisely and rapidly on the substrate 31 such that the antenna module 3 of this invention is suitable for mass-production. Furthermore, since the substrate 31 or the grounding metal plate 34 is easily fastened onto the housing 10, the transmission line 35 can be accurately soldered to the conductor 32 and the first conductive portion 314.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A multi-frequency antenna module for a portable electronic apparatus with a housing, comprising:
a dielectric substrate adapted to be mounted in the housing and having opposite first and second surfaces;
a micro-strip conductor disposed on said first surface of said substrate;
a radiating element disposed on said second surface of said substrate and coupled electrically to said micro-strip conductor;
a grounding metal plate mounted on said second surface of said substrate and coupled electrically to said radiating element; and
a transmission line having a first conducting portion coupled electrically to said micro-strip conductor, and a second conducting portion coupled electrically to said grounding metal plate.

2. The multi-frequency antenna module as claimed in claim 1, wherein said radiating element is a slot antenna.

3. The multi-frequency antenna module as claimed in claim 1, wherein said transmission line is a coaxial cable.

4. The multi-frequency antenna module as claimed in claim 1, wherein said conductor has opposite end portions coupled electrically and respectively to said radiating element and said transmission line.

5. The multi-frequency antenna module as claimed in claim 1, wherein said substrate is a printed circuit board.

6. The multi-frequency antenna module as claimed in claim 1, wherein said radiating element is coupled electrically to said conductor by means of a conductive via that extends through said radiating element, said substrate and said conductor.

7. The multi-frequency antenna module as claimed in claim 1, wherein said grounding metal plate is soldered on said second surface of said substrate.

8. The multi-frequency antenna module as claimed in claim 1, wherein each of said substrate and said grounding metal plate is formed with a plurality of fastener holes.
